(19) United States
(12) Patent Application Publication
(10) Pub. No.: US 2010/0040048 A1
(43) Pub. Date: Feb. 18, 2010

(54) Address Resolution in a Communication System

(76) Inventor: Hannu Vormisto, Espoo (FI)

Correspondence Address: ERICSSON INC., 6300 LEGACY DRIVE, M/S EVR 1-C-11, PLANO, TX, 75024, US

(21) Appl. No.: 12/441,044

(22) PCT Filed: Sep. 14, 2006
(86) PCT No.: PCT/EP06/66360

§ 371 Date: Mar. 12, 2009

(51) Int. Cl. H04L 12/66

(52) U.S. Cl. 370/352

(57) ABSTRACT

Apparatus for resolving a local TEL Uniform Resource Identifier to a service Uniform Resource Identifier for routing a message over an IP-based communication system. The apparatus comprises first processing means (2) for constructing a domain name system query string incorporating digits of the TEL Uniform Resource Identifier and a Context Identifier associated with the TEL Uniform Resource Identifier, and second processing means (3) for performing a Domain Name System lookup using said domain name system query string and for receiving in response said service Uniform Resource Identifier

### FIELD OF THE INVENTION

The present invention relates to address resolution in a communication network and in particular though not necessarily to the resolution of local TEL Uniform Resource Identifiers (URIs) to addresses for routing across an IP network.

### BACKGROUND TO THE INVENTION

IP Multimedia services provide a dynamic combination of voice, video, messaging, data, etc. within the same session. By growing the number of basic applications and the media which it is possible to combine, the number of services offered to the end users will grow, and the inter-personal communication experience will be enriched. This will lead to a new generation of personalised, rich multimedia communication services, including so-called “combinational IP Multimedia” services which are considered in more detail below. IP Multimedia Subsystem (IMS) is the technology defined by the Third Generation Partnership Project (3GPP) to provide IP Multimedia services over mobile communication networks (3GPP TS 22.228, TS 23.218, TS 23.228, TS 24.228, TS 24.229, TS 29.228, TS 29.229, TS 29.328 and TS 29.329 Releases 5 to 7. IMS provides key features to enrich the end-user person-to-person communication experience through the use of standardised IMS Service Enablers, which facilitate new rich person-to-person (client-to-client) communication services as well as person-to-content (client-to-server) services over IP-based networks.

FIG. 1 illustrates schematically how the IMS fits into the mobile network architecture in the case of a GPRS/PS access network. Call/Session Control Functions (CSCFs) operate as SIP proxies within the IMS. The 3GPP architecture defines three types of CSCFs: the Proxy CSCF (P-CSCF) which is the first point of contact within the IMS for a SIP terminal; the Serving CSCF (S-CSCF) which provides services to the user that the user is subscribed to; and the Interrogating CSCF (I-CSCF) whose role is to identify the correct S-CSCF and to forward to that S-CSCF a request received from a SIP terminal via a P-CSCF.

In the IMS, users are allocated one or more “public user identities”. Users' home operators are responsible for this allocation. A public user identity is typically either a SIP URI or a TEL URI. A SIP URI typically has the format “sip.firstname.lastname@operator.com”. A TEL URI on the other hand represents an E.164 phone number. As defined in IETF RFC 3966, a TEL URI representing a globally unique phone number looks like “tel: +44-123-456-7890”.

The use of global TEL URIs allows the IMS to break out calls from an IMS client to a circuit switched network, as well as allowing subscribers of a circuit switched network to reach IMS subscriber. It also allows IMS subscribers to continue to use traditional telephone numbers, rather than SIP URIs, to reach other IMS subscribers. Whilst messages can be routed through the IMS directly using SIP URIs (using DNS look-up operations to identify next hop IP addresses), the use of TEL URIs requires the IMS to first perform a look-up operation to map TEL URIs to SIP URIs. Within the IMS, mapping of TEL URIs to SIP URIs is typically performed at the allocated S-CSCF.

Globally unique TEL URIs can be resolved to SIP URIs using Telephone Number Mapping (ENUM) practices as described in IETF RFC 3761 and 3764. ENUM provides for the mapping of globally unique TEL URIs to Internet routable URIs, including SIP URIs, using the Internet Domain Name System (DNS). More particularly, the domain name space “e164.arpa” has been assigned by the Internet Assigned Numbers Authority (IANA) to facilitate E164 number mapping. Mapping is achieved by taking the complete E.164 address and removing all non-digit symbols (e.g. “+”) from the address. The digit string is reversed and a “.” is placed between each pair of digits. The string “.e164.arpa.” is then appended to make a complete DNS query string. So, for example, the E.164 number “+44 1234 456789” would be translated to the DNS query string “9.8.7.6.5.4.3.2.1.4.5.e164.arpa.”.

ENUM relies upon URI resource records known as Naming Authority Pointers (NAPTR) records stored in the DNS server which “owns” the TEL URI. A NAPTR record contains the following fields:
An Order field to specify the order in which multiple NAPTR records must be processed;
A Preference field to determine the processing order when multiple NAPTR records have the same order value;
A Service field specifying the resolution protocol and service, for example “E2U+SIP” specifies that a NAPTR record relates to the SIP service and that the E2U (E.164 to URI) resolution protocol should be used. “E2U+mailto” specifies that a NAPTR record relates to a mail service;
Flags modifying actions of further DNS lookups;
A regular expression to allow the query client to rephrase the original request in a DNS format; and
A Replacement field to define the next DNS query object.

An ENUM query to the DNS system returns one or more NAPTR records which identify respective services. The agent making the DNS query processes the NAPTR records in the required order and selects a service that matches the service characteristics of the original request (telephone call, text message, etc). The result is a URI, for example the SIP URI sip:jim@operator.com. The agent then makes a further DNS query to resolve the domain part of the URI (sip.operator.com) to an IP address and port number for a preferred server for the service.

Tel URIs may also be specified in a local number format, i.e. a format that is not globally unique. Routing with local TEL URIs will require the inclusion within the TEL URI of a “phone-context” as defined in the IETF RFC 3966. A phone-context is a parameter which identifies the domain (e.g. network) within which the local format number exists. A routing node within this domain will recognise a phone-context identifying the domain, and will route a call using a local TEL URI to Internet URI mapping table. However, local TEL URIs cannot be resolved within the same DNS domain (e164.arpa) as the most significant digits (from a routing point of view) are missing.

A mechanism for achieving global routing using local TEL URIs might involve performing an analysis of the phone-context locally at the routing node. The node would maintain a look-up table mapping phone-contexts to national and international number prefixes. For example, the phone-context “ericsson.com” might be mapped to the number prefix “468”. However, this approach lacks scalability and updating of information would be difficult.

### SUMMARY OF THE PRESENT INVENTION

According to a first aspect of the present invention there is provided apparatus for resolving a local TEL Uniform Resource Identifier to a service Uniform Resource Identifier for routing a message over an IP-based communication system, the apparatus comprising:
first processing means for constructing a domain name system query string incorporating digits of the TEL Uniform Resource Identifier and a Context Identifier associated with the TEL Uniform Resource Identifier; and
second processing means for performing a Domain Name System lookup using said domain name system query string and for receiving in response said service Uniform Resource Identifier.

It is to be understood that the terms “TEL Uniform Resource Identifier” and “Context Identifier” are used here in accordance with the definitions set out in IETF RFC 3966 or in evolutions of this RFC. In order to facilitate its incorporation into the domain name system query string, the Context Identifier should specify a top level domain and one or more successive subdomains.

Said first processing means is arranged to perform the following steps to create the domain name system query string:

Remove characters from the TEL Uniform Resource Identifier with the exception of digits;

Reverse the order of the digits;

Place the separator “.” between digits; and

Append the Context Identifier to the string.

Preferably, said second processing means is arranged to receive from the Domain Name System one or more NAPTR records. The or each NAPTR record contains a service Uniform Resource Identifier and, if necessary, the second processing means makes a selection from these.

Said service URI may be a SIP URI, or any other appropriate URI.

According to one embodiment of the present invention, said apparatus is a Serving Call/Session Control Function server. However, the apparatus may also be another server within the IMS, or indeed a server within a private network, e.g. a Virtual Private Network or VPN.

According to a second aspect of the present invention there is provided a method of resolving a local TEL Uniform Resource Identifier to a service Uniform Resource Identifier for routing a message over an IP-based communication system, the method comprising:
combining digits of the TEL Uniform Resource Identifier and a Context Identifier associated with the TEL Uniform Resource Identifier to form a domain name system query string; and
performing a Domain Name System lookup using said domain name system query string receiving in response said service Uniform Resource Identifier.

Preferably, said step of combining the TEL Uniform Resource Identifier and a Context

Identifier associated with the TEL Uniform Resource Identifier comprises:

Removing characters from the TEL Uniform Resource Identifier with the exception of digits;

Reversing the order of the digits;

Placing the separator “.” between digits; and

Appending the Context Identifier to the string.

Preferably, Domain Name System lookup results in the return of one or more NAPTR records. An appropriate service Uniform Resource Identifier is identified from the NAPTR record(s).

### BRIEF DESCRIPTION OF THE DRAWINGS

FIG. 1 illustrates schematically the IP Multimedia Subsystem implemented over a 3GPP network;

FIG. 2 illustrates a signalling process associated with a call set up within the IMS using a local TEL URI; and

FIG. 3 illustrates schematically an S-CSCF within the IMS.

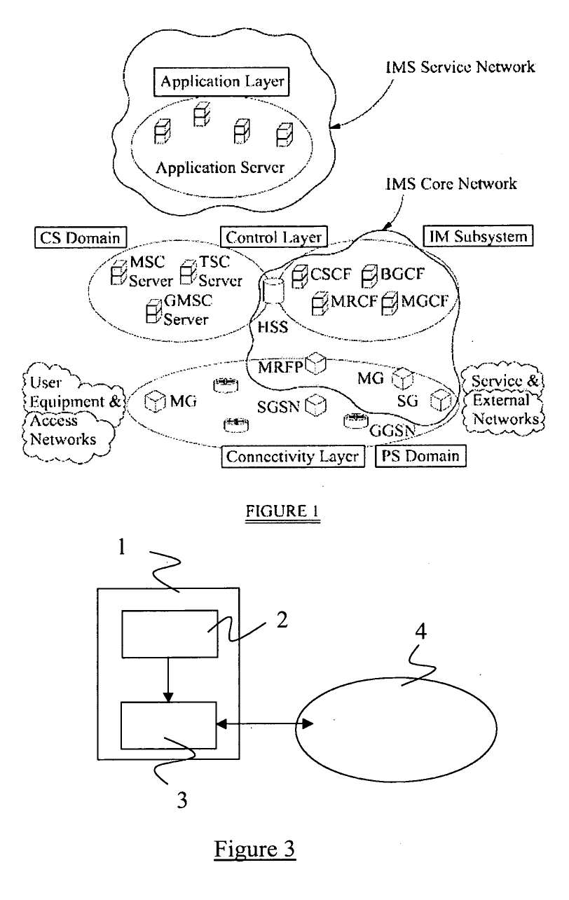

### DETAILED DESCRIPTION OF CERTAIN EMBODIMENTS

To aid understanding of the following discussion, reference should be made to the following IETF Request For Comments (RFCs):

RFC 3761: The E.164 to Uniform Resource Identifiers (URI) Dynamic Delegation Discovery System (DDDS) Application (ENUM);

RFC 3762 Telephone Number Mapping (ENUM) Service Registration for H.323;

RFC 3764: ENUM service registration for Session Initiation Protocol (SIP) Addresses-of-Record; and

RFC 3966: The tel URI for Telephone Numbers.

RFC3966 is concerned with specifying the structure of a TEL URI for use in routing messages across an IP-based network such as the IMS. It is envisaged that TEL URIs will be used as destination addresses for SIP messages, supplementing the specific SIP URIs as described above. More particularly, RFC3966 specifies that a TEL URI will contain a phone number part. In the event that this phone number is not a globally unique number however, the TEL URI must include a phone-context. A phone-context can be provided by a global number digit set, for example the initial digits of an E.164 number or Mobile Station International ISDN (e.g. +441234), or by a domain name, e.g. operator.com. For the purpose of this discussion, it is assumed that the phone-context is provided by a domain name.

It is proposed here to use the phone-context associated with a local TEL URI as the root domain for the local numbers in that domain. The number digits of the local TEL URI can then be resolved in that domain using a DNS ENUM-based procedure with NAPTR lookup practices. Considering this process in more detail, the main steps in the resolution process are as follows:
1. Remove from the “local-number-digits” all characters with the exception of the digits. This step is simply to remove all “visual-separator” characters such as “(” from the local-number-digit. For example “(848) 2481” would be mapped to “8482481”.
2. Put dots (“.”) between each digit. For example, 8.4.8.2.4.8.1
3. Reverse the order of the digits. For example, 1.8.4.2.8.4.8
4. Append the string taken from “phone-context” to the end of the reversed string. For example, 1.8.4.2.8.4.8.ericsson.com

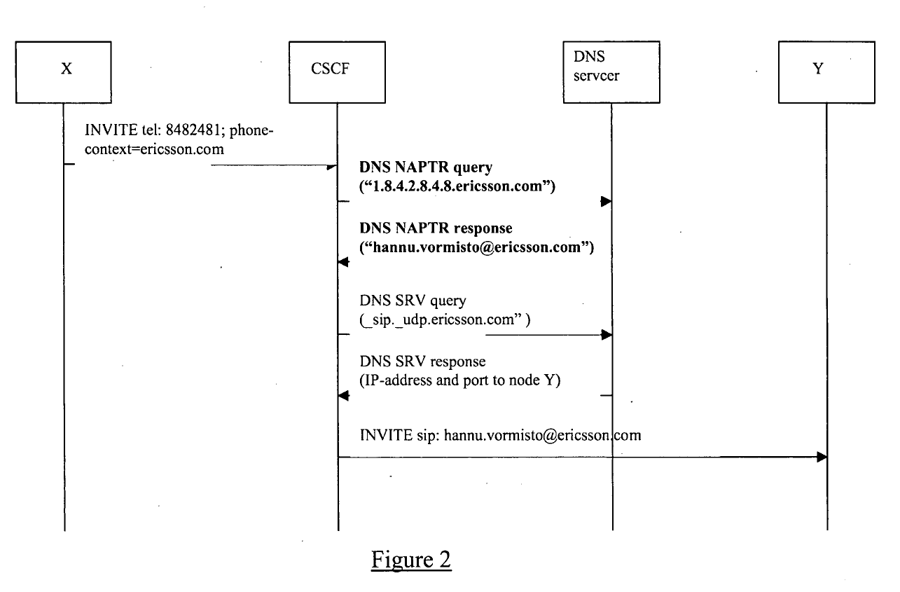

Within the IMS, this process is carried out at the S-CSCF. The S-CSCF then uses the result as a DNS query string, sending the query to a DNS root nameserver. This DNS server will return the IP address of the nameserver responsible for the “ericsson.com” domain. The S-CSCF will then re-send the query to this lower level nameserver which will either return the appropriate NAPTR records if it holds these or return the IP address of a further lower level nameserver if it does not (in which case the query is repeated for a third time and so on until the NAPTR records are retrieved). An example signalling flow is illustrated in FIG. 2, whilst FIG. 3 illustrates schematically functional entities within an S-CSCF 1, namely processing means 2 for generating a DNS query string and processing means 3 for receiving this string, sending a DNS query to the DNS 4, and processing the DNS response.

In the example given above, the phone-context “ericsson.com” is company specific. However, the procedure is not limited to company internal numbers and PSTN numbers that individual companies are managing. The procedure can be used for resolving all types of “local-number”, even nationally significant numbers (i.e. numbers that are unique within a country but which to not possess an international dialling prefix) assuming that the national authorities set and manage a country specific root domain for resolving nationally significant numbers. For example, the phone-context “e164.se” could be stipulated as a root domain for nationally significant E.164 numbers in Sweden.

This procedure is not limited only to the recovery NAPTR “E2U+service” records, but covers also other type of record names. For example, a service field “L2U+service” (i.e. local number to URI) could be specified. This would allow the procedure to be used even if those service names that have already been registered for this type usage by IANA—like “E2U+SIP” [RFC 3764] and “E2U+H323” [RFC 3762].

As has already been noted above, ENUM is not limited to resolving TEL URIs to SIP URIs, and it can be used for resolving TEL URIs to other type of Internet routeable URIs, e.g. H.323 addresses. Application of the present invention would allow the mapping of local TEL URIs to any appropriate URI type using the phone-context associated with the TEL URI.

It will be appreciated by the person of skill in the art that various modifications may be made to the above described embodiments without departing from the scope of the present invention. For example, whilst the discussion presented above has been concerned with the retrieval of NAPTR records by the querying agent, the procedure may also be used to retrieve other types of records, for example: A records used to retrieve IPv4 addresses (RFC 1034); AAAA records used to obtain IPv6 addresses (IETF RFC 2596); and SRV records (IETF RFC 2782).

1-9. (canceled)

10. An apparatus for resolving a local Telephone Uniform Resource Identifier (TEL URI) to a service URI for routing a message over an IP-based communication system, the apparatus comprising:
communication means for receiving the message, said message including the TEL URI and a phone context associated with the TEL URI;
first processing means for constructing a domain name system (DNS) query string incorporating digits of the TEL URI and the associated phone context associated with the TEL URI; and
second processing means for performing a DNS lookup with a DNS server utilizing the DNS query string, and for receiving the service URI from the DNS server in response.

11. The apparatus according to claim 1, wherein the first processing means includes means for removing characters from the TEL URI with the exception of digits, reversing the order of the digits, placing the separator “.” between digits, and appending the phone context to the reversed digits.

12. The apparatus according to claim 1, wherein the second processing means receives at least one Naming Authority Pointers (NAPTR) record from the DNS server.

13. The apparatus according to claim 12, wherein the or each NAPTR record includes a service URI.

14. The apparatus according to claim 13, wherein the service URI is a Session Initiation Protocol (SIP) URI.

15. The apparatus according to claim 10, wherein the apparatus is implemented in a Serving Call/Session Control Function server.

16. A method of resolving a local Telephone Uniform Resource Identifier (TEL URI) to a service URI for routing a message over an IP-based communication system, the message containing both the TEL URI and an associated phone context, the method comprising the steps of:
forming a domain name system (DNS) query string by combining digits of the TEL URI with the associated phone context;
performing a DNS lookup with a DNS server utilizing the DNS query string; and
receiving the service URI from the DNS server in response.

17. The method according to claim 16, wherein the step of forming a DNS query string includes:
removing characters from the TEL URI except for digits;
reversing the order of the digits;
placing the separator “.” between digits; and
appending the phone context to the reversed digits.

18. The method according to claim 16, wherein the step of receiving the service URI includes receiving a Naming Authority Pointers (NAPTR) record from the DNS server, said NAPTR record including the service URI.

19. The method according to claim 16, wherein the method is performed at a Serving Call/Session Control Function server:
